(19) United States
(12) Patent Application Publication
(10) Pub. No.: US 2009/0271352 A1
(43) Pub. Date: Oct. 29, 2009

(54) System, Method and Software for Selecting Among Available Connections for Accessing Content from a Remote Server Using a Client Computing Device

(76) Inventors: Darrell Gentry, Mountain View, CA (US); Nathan Burns, San Francisco, CA (US)

Correspondence Address: HARNESS, DICKEY, & PIERCE, P.L.C, 7700 Bonhomme, Suite 400, ST. LOUIS, MO, 63105, US

(21) Appl. No.: 12/325,810

(22) Filed: Dec. 1, 2008

Related U.S. Application Data
(60) Provisional application No. 60/991,299, filed on Nov. 30, 2007.

(51) Int. Cl. G06F 15/16; G06N 5/02

(52) U.S. Cl. 706/47; 709/227; 709/203; 726/15

(57) ABSTRACT

A computing device may have one or more physical connections and/or one or more virtual connections to computer network(s). A user of the computing device may desire access to data from a remote server. According to the present disclosure, the performance of accessing the remote server via the one or more physical connections and/or the performance of accessing the remote server via the one or more virtual connections are tested. Based on the test results, and possibly user-defined rules as well, one of the physical or virtual connections is selected for accessing content from the remote server using the computing device. Alternatively, one of the physical or virtual connections can be selected based solely on user-defined rules.

### CROSS REFERENCE TO RELATED APPLICATION

This application claims the benefit of U.S. Provisional Application No. 60/991,299 filed Nov. 30, 2007, the entire disclosure of which is incorporated herein by reference.

### BRIEF DESCRIPTION OF THE DRAWINGS

FIG. 1 illustrates one example of a software program for a client computing device according to the present disclosure.

FIG. 2 illustrates a client device communicating with a remote server via a selected connection according to the present disclosure.

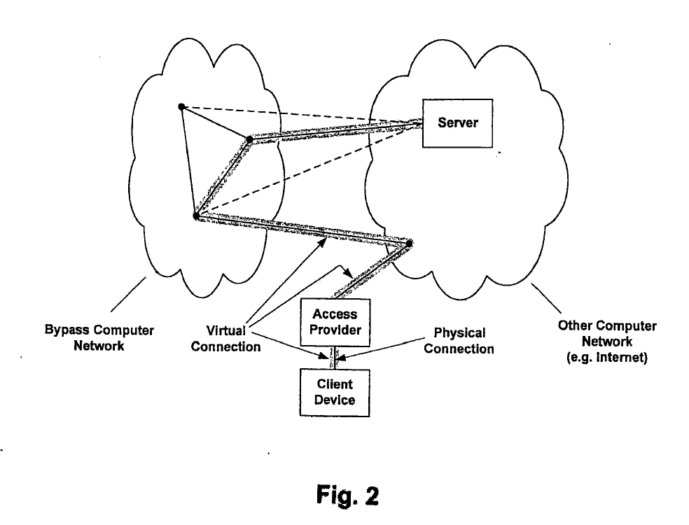

### DESCRIPTION

A client computing device can have one or more physical connections and/or one or more virtual connections to one or more IP communications networks. The client computing device may be, for example, a personal computer, a home broadband router, a game console, etc. The physical connection(s) may be a fiber, cable broadband, DSL, wireless, satellite, modem/dialup or other connection to a network access provider. The virtual connection(s) may be tunnels established between the client computing device and the IP communication network(s) through a physical connection. The tunnel(s) may be established using a tunneling protocol (to establish a virtual connection through a physical connection) such as Internet protocol 4 (also referred to as “ipencap” or “IP within IP tunneling”) or other suitable means.

The client computing device is preferably configured (via software, an integrated circuit or otherwise) for testing the performance of accessing a remote server via one or more physical connections, and for testing the performance of accessing the remote server via one or more virtual connections. This testing can be performed by the client computing device on its own or in cooperation with one or more other computer devices, including computer devices residing on the IP communications network(s). Based on the test results, and optionally user-defined rules as well, one of the physical or virtual connections is selected for accessing content from the remote server using the computing device. This selection can be made by the client computing device, or by another computing device in communication with the client computing device. The selected connection is then used for accessing content from the remote server using the client computing device. In some embodiments, the selection is made before a connection is established for routing data (other than performance testing data) between the client computing device and the remote server, and this selection is not changed before such connection is terminated.

In other embodiments, the client computing device is configured for testing the performance of accessing the remote server via multiple virtual connections. Based on the test results, and optionally user-defined rules as well, one of the virtual connections is selected for accessing content from the remote server using the computing device. In still other embodiments, one of multiple virtual connections is selected based solely on user-defined rules, without regard to or requiring performance testing.

As noted above, the selection of a particular connection can be based not only on the performance testing, but also in response to user-defined rules. For example, a user may specify that if the latency to a particular server is less than forty milliseconds, the physical connection should always be used (e.g., to avoid usage fees associated with the virtual connection). The same user may also specify, for example, that a virtual connection should be used if latency to a particular server is more than forty milliseconds and the virtual connection is faster than the physical connection, and/or that the virtual connection should always be used if latency to a particular server is more than one hundred milliseconds (e.g., if the virtual connection provides a better user experience, such as less jitter, than the physical connection for especially distant servers, regardless of which is faster). Of course, a user could also specify to always use the fastest connection, or otherwise specify rules and preferences that affect the selection of a particular connection for accessing data from a remote server.

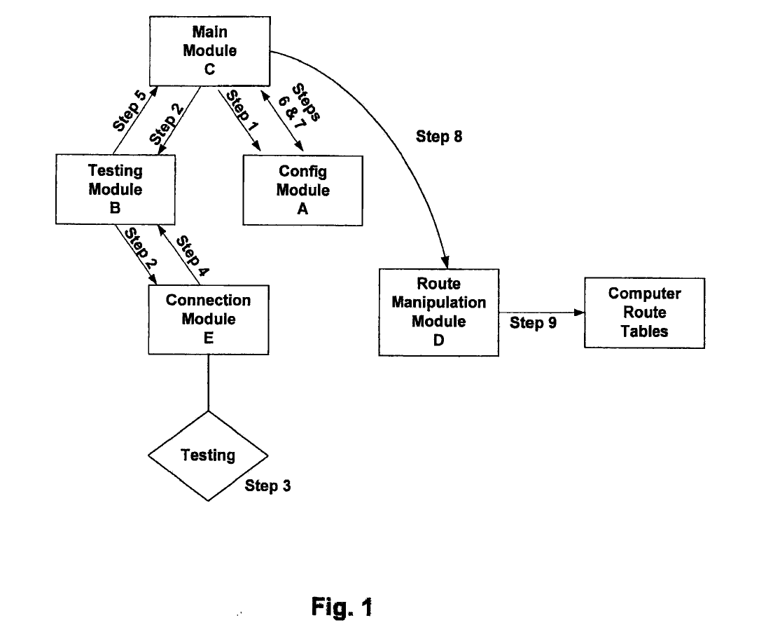

FIG. 1 illustrates one example of a suitable software program for a client computing device. As shown in FIG. 1, the software program includes a configuration module (a), a testing module (b), a main module (c), and a route manipulation module (d). A connection module (e) may also be included within the software program, or the software program may work in conjunction with a connection module (e) previously installed on the client computing device. The configuration module includes location information for remote servers a user wishes to access. This location information may be stored locally on the client computing device, accessed from one or more other computing devices (e.g., in a data center or residing on the Internet), or a combination thereof. The configuration module (and/or other computing device(s)) may also store user-defined rules (which may include user preferences) to be used, in conjunction with the performance testing, for selecting a particular connection. The main module retrieves content from the configuration module (step 1), then orders the testing module to initiate tests to the remote servers that are to be optimized (step 2). The testing module utilizes the connection module to perform tests to the remote servers over the available network options, including one or more physical connections and one or more virtual connections (step 3). Multiple virtual connections may be to separate networks, or could be to different ingress points of the same network. The communications module communicates the test results back to the testing module (step 4). The testing module compiles and formats the tests and communicates the test results to the main module (step 5). The main module requests the user-defined rules from the configuration module (step 6). The configuration module provides the requested data back to the main module (step 7). Based on the user-defined rules, the main module communicates with the route manipulation module to select one of the connections for routing traffic to one of the remote servers (step 8). The router manipulation module then manipulates the route tables of the computing device to cause the computing device to route data to the remote server over the selected connection (step 9). The main module repeats this process until all routes to the remote server have been tested, and may then repeat the entire process after waiting a configurable amount of time.

The testing module may be configured to test, among other things, latency, packet loss, jitter, number of hops (i.e., the number of routers, and thus routing decisions, in a given path), or other factors which impact network performance. Performance tests can be initiated in parallel to different network destinations so that the process of optimizing the routes to those destinations can occur quickly. Further, the testing module may display the outcome of the tests on the computing device display. The testing module may also store the results of previous network tests, either locally on the computing device or at a remote location.

As noted above, the configuration module can include location information for pre-identified servers, which is stored locally, remotely or some combination thereof. Further, the configuration module can capture user-defined rules (including preferences) related to the pre-identified servers. These user-defined rules may include, without limitation, preferred routing parameters to a specific network destination and/or at a specific time of day, for instance during peak usage times or off-peak times, percent differences between options, percent error between network options, etc. For example, if a computing device has a virtual connection and a physical connection, the user-defined rules may specify that if the speeds of the two connections are the same, select the physical connection for accessing content from a remote server, or select the connection with the lowest packet loss. The user-defined rules may also specify that the virtual connection should be used at particular time and/or on particular days. Further, the user-defined rules may indicate that if the latency of accessing a remote server using one connection is within five percent of the other connection, select the physical connection for accessing the remote server (e.g., if using the physical connection costs less than using the virtual connection). Of course, various other user-defined rules can be employed in selecting a particular connection for accessing content from a remote server.

The teachings of this disclosure can be applied to a home router having a single physical connection and at least one virtual connection. In addition to the modules noted above, the home router may also include a network address translation (NAT) rule manipulation module that modifies NAT rules on the home router based on selections and routing decisions made by the other modules to thereby provide access to other computing devices on the home network to the selected network path.

In an alternative embodiment, the software program is configured to work with one or more remote match-maker services, which establish peer-to-peer connections between computing devices. In those applications, the remote server(s) are selected by the match-maker service(s) rather than the user. The configuration module captures the network addresses of the remote servers designated by the match-maker service, and tests performance to such addresses over the physical and virtual connections as described above. Based on the performance tests and criteria contained in the match-maker service, the match-maker service designates the preferred connection for routing data between the client computing device and one of the remote servers. The routing module then routes traffic over the preferred connection(s) to the various remote servers.

The teachings of this disclosure can be applied, for example, to on-line video gaming applications in which clients communicate with remote video game servers (e.g., in different cities and/or states than the client) over a portion of the Internet. It should be understood, however, that the teachings of this disclosure are not so limited and can be applied to a wide variety of data communication applications.

The above description is to be construed as exemplary only and does not describe every possible instance of the system. Numerous alternatives could be implemented, using combinations of current or future technologies, which would still fall within the scope of the claims. As an example, different tunneling protocols could be utilized to establish virtual connections or tunnels, or different internet connectivity means could be utilized as the physical connection. Further, the software functionality described above may be embodied in an application-specific or programmable integrated circuit, which is then installed in the client computing device.

1. A method of accessing content from a server using a client device, the client device having at least first and second connections to one or more remote computers, the method comprising:
testing the performance of the first connection;
testing the performance of the second connection; and
selecting, in response to the performance testing, the first connection or the second connection for accessing content from the server using the client device.

2. The method of claim 1 wherein testing includes testing the performance of accessing the server over the first connection and testing the performance of accessing the server over the second connection.

3. The method of claim 1 wherein the selecting is in response to the performance testing and user-defined rules.

4. The method of claim 3 further comprising defining the user-defined rules in response to user input.

5. The method of claim 4 further comprising receiving the user input via the client device.

6. The method of claim 4 wherein defining includes defining the user-defined rules in response to user input and as a function of the performance testing.

7. The method of claim 1 wherein the server resides on a public computer network.

8. The method of claim 7 wherein the server is a video game server.

9. The method of claim 7 wherein the first connection is a physical connection and the second connection is a virtual connection.

10. The method of claim 9 wherein the virtual connection connects the client device to a first private computer network capable of accessing the server through the public computer network.

11. The method of claim 10 wherein the first private computer network includes at least first and second egress gateways capable of accessing said server, wherein testing the performance of the second connection includes testing the performance of accessing the server through the first egress gateway and testing the performance of accessing the server through the second egress gateway, and wherein selecting includes selecting the first connection, the second connection and the first egress gateway, or the second connection and the second egress gateway for accessing content from the server using the client device.

12. The method of claim 1 wherein the client device has a third connection to a second private computer network capable of accessing the server through the public computer network, wherein the method further includes testing the performance of the third connection, and wherein selecting includes selecting the first connection, the second connection or the third connection for accessing content from the server using the client device.

13. The method of claim 1 wherein testing includes determining the speed, packet loss, jitter or number of hops encountered when accessing the server.

14. The method of claim 1 wherein testing includes testing the performance of said connections at various times of day, and wherein selecting includes selecting one of said connections in response to the performance testing and the time of day.

15. The method of claim 1 wherein the first connection is a physical connection and the second connection is a virtual connection.

16. The method of claim 1 wherein the first connection and the second connection are virtual connections.

17. A method of accessing content from a server using a client device, the client device having at least first and second connections to one or more remote computers, the method comprising selecting, according to user-defined rules, the first connection or the second connection for accessing content from the server using the client device.

18. The method of claim 17 wherein the first connection is a physical connection and the second connection is a virtual connection.

19. The method of claim 17 wherein the first connection and the second connection are virtual connections.

20. A computer-readable medium having computer-executable instructions for performing the method of claim 1.

21-27. (canceled)
